(19) United States
(12) Patent Application Publication
(10) Pub. No.: US 2007/0116576 A1
(43) Pub. Date: May 24, 2007

(54) Fan blade unit in a centrifugal fan

(76) Inventors: Bor-Haw Chang, Taipei (TW); Jun-Chien Yen, (US)

Correspondence Address: G. LINK CO. LTD., 3550 BELL ROAD, MINOOKA, IL, 60447, US

(21) Appl. No.: 11/281,809

(22) Filed: Nov. 18, 2005

(51) Int. Cl. B64C 27/46

(52) U.S. Cl. 416/228

(57) ABSTRACT

A fan blade unit in a centrifugal fan includes a hub and a plurality of fan blades connected to the periphery of the hub and each of the fan blades at least has an end edge with at least a baffle part being joined to the end edge and extending toward another one of the fan blades next to it.

### BACKGROUND OF THE INVENTION

1. Field of the Invention

The present invention is related to a fan blade unit in a centrifugal fan and particularly to fan structure for a centrifugal fan capable of dissipating heat.

2. Brief Description of the Related Art

Due to the semiconductor and information industry developing rapidly in the recent years, products gradually approaches a trend with high performance, high frequency, high speed, lightness and thinness gradually and the chips is designed being minimized gradually in size. As a result, intensity of heat generation provided by the electronic components is getting higher and it easily leads to the electronic component running unstably. Thus, if heat is capable of being removed properly is one of key points for successful product development.

Less heat was generated from the computer in the past so that requirement of heat dissipation system was less strict. The current computer provides faster operation speed with more powerful functions and in order to solve problem of heat dissipation for the electronic component and bring the heat generated by the electronic component outside the host unit, usually, some heat dissipation devices such as the thermosyphon, the heat pipe and the heat sink are mounted in the host unit of the computer to assist removing heat from the electronic component and the entire computer system. Nevertheless, the heat dissipation system composed of a fan associated with the heat sink is more acceptable by the users while the economic effect is considered with the heat dissipation function. The fan blade wheel is driven by a prime mover to transform electric power to mechanical energy and energy transmitted with the fan blade wheel forces the air to flow for increasing coefficient of convection in a space. Flow movement resulted from pressure change and velocity increase carries heat from the heat sink directly to attain purpose of heat dissipation. Hence, in order to increase amount of heat removal in a limited space, design of fan becomes a vital subject of research.

Conventionally, there are two kinds of fans, the axial flow fan and the centrifugal fan. The centrifugal fan induces the air flowing radially or perpendicular to the shaft. When the blade wheel rotates, the air inters along the center of the blade wheel and energy is obtained due to centrifugal force of the air itself. The air flows outward radially along the fan blades such that configuration of the respective fan blade significantly affects performance of the entire fan. Hence, the respective fan blade provides three different types: (a) back bending type; (b) radial type; and (c) front bending type. The air pressure is higher for the centrifugal fan such that the centrifugal fan is used in a system with greater resistance. Further, the flow field of the centrifugal fan is extremely complicated due to the air turning into radial direction via rotation of the blade wheel. Under this circumference, air in the fan wheel occurs phenomena such as recirculation, reversed flow and separation. Hence, how to improve these problems for promoting effect of heat removal is a subject worth us to investigate.

Referring to FIGS. 1 and 2, a conventional centrifugal fan provides a blade wheel, which has a hub 11 and a plurality of fan blades 12 surrounding the hub 11 and extending outward from the hub 11. The fan blades 12 are radially disposed at the periphery of the hub 11 and the fan blades are changed at the radial parts thereof such as the respective fan blade 12 near the hub being flat as shown in FIG. 1 or the respective fan blade being bending radially from the end at the hub to the end at the outer side as shown in FIG. 2.

Referring to FIGS. 3 and 4, the fan being joined in a case is illustrated. The case includes an upper case member 13 and a lower case member 14. The upper case member 13 has a first hole. 131 at the surface thereof and the lower case member 14 has a second hole 141 at the surface thereof. The upper case member 13 is integrally joined to the lower case member 14 to define a spiral flow passage 15 to receive the hub 11 and the fan blades 12. An outlet 16 is formed with the upper case member 13 and the lower case member 14 at a lateral side thereof respectively. When the hub 11 rotates with the fan blades 12 to suck fluid, the fluid enters via the first hole 131 and the second hole 141 and rotational force urges the fluid ejecting outward along the fan blades 12 before blowing toward along the spiral flow passage 15.

The preceding fan blades 12 is straight in the axial direction and air pressure at the first hole 131 is supposed to be equal to that at the second hole 141. However, the problem in the practical application resides in that due to conditions of flowing in at the first hole 131 is different from those at the second hole 141, for instance, a plurality of support ribs being disposed at the second hole 141, fluid is unable to discharge via the outlet 16 completely once the resistance is slightly higher and then the fluid left in the fan flows reversely outward via the first hole 131 or the second hole 141 to decrease flow rate of incoming fluid through the first hole 131 or the second hole 141. Further, louder noise is generated at the time of the reversed flow impacting the incoming flow.

### SUMMARY OF THE INVENTION

A main object of the present invention is to provide a fan blade unit in a centrifugal fan in which each of the fan blades extends at least a baffle part from at least an end edge thereof to prevent from the fluid being reversed flow.

In order to achieve the preceding object, the fan blade unit in a centrifugal fan according to the present invention includes a hub and a plurality of fan blades connected to the periphery of the hub and each of the fan blades at least has an end edge with at least a baffle part being joined to the end edge and extending toward another one of the fan blades next to it.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a perspective view of the first type of the conventional centrifugal fan;

FIG. 2 is a perspective view of the second type of the conventional centrifugal fan;

FIG. 3 is a disassembled perspective view of the conventional centrifugal fan being received in an upper and a lower case member parts;

FIG. 4 is an assembled perspective view of the conventional centrifugal fan being received in an upper and a lower case member parts;

FIG. 5 is a sectional view of FIG. 4;

FIG. 6 is a perspective view of the preferred embodiment of a centrifugal fan according to the present invention;

FIG. 7 is a sectional view of the fan blade on the centrifugal fan according to the present invention;

FIG. 8 is a disassembled perspective view illustrating the centrifugal fan being joined with an upper and lower cover parts according to the present invention;

FIG. 9 is an assembled perspective view illustrating the centrifugal fan being joined with an upper and lower cover parts according to the present invention;

FIG. 10 is a sectional view illustrating the centrifugal fan being joined with an upper and lower cover parts according to the present invention;

FIG. 11 is a sectional view illustrating another type of the fan blade on the centrifugal fan according to the present invention;

FIG. 12 is a sectional view illustrating a further type of the fan blade on the centrifugal fan according to the present invention;

FIG. 13 is a sectional view illustrating a still further type of the fan blade on the centrifugal fan according to the present invention;

FIG. 14 is a sectional view illustrating a still further type of the fan blade on the centrifugal fan according to the present invention;

FIG. 15 is a sectional view illustrating a still further type of the fan blade on the centrifugal fan according to the present invention; and

FIG. 16 is a sectional view illustrating a still further type of the fan blade on the centrifugal fan according to the present invention.

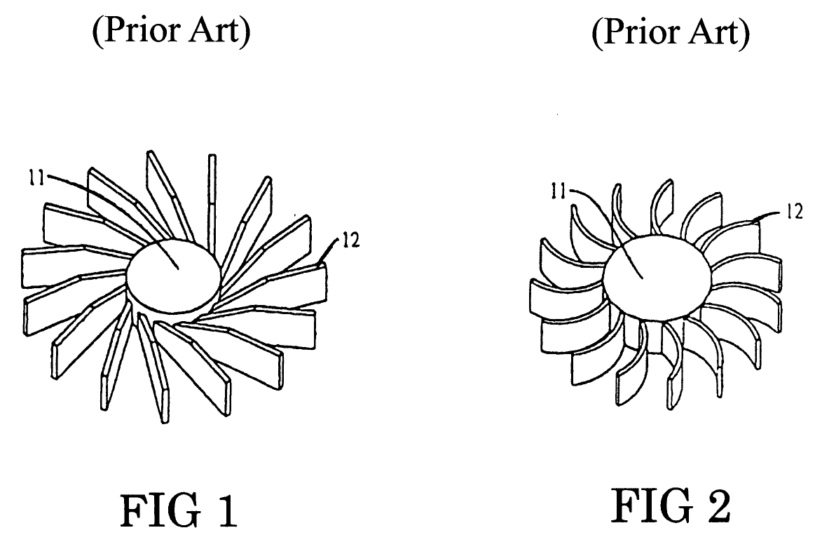

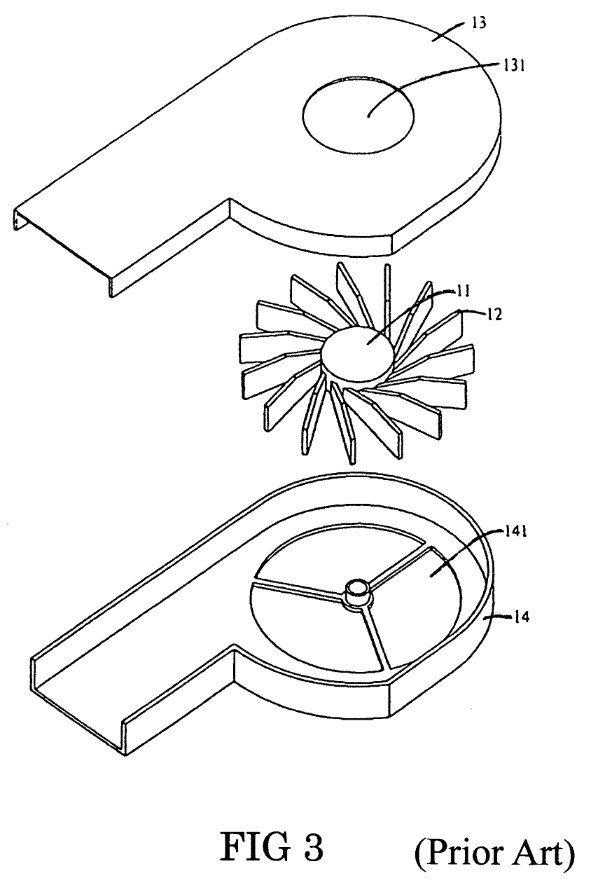

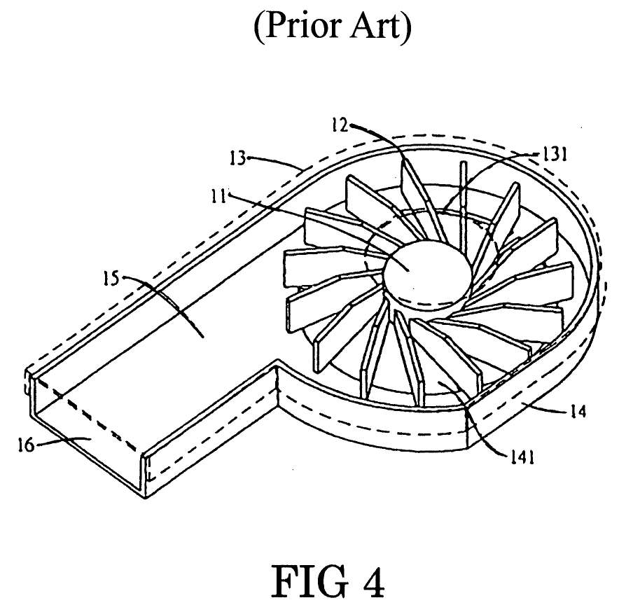

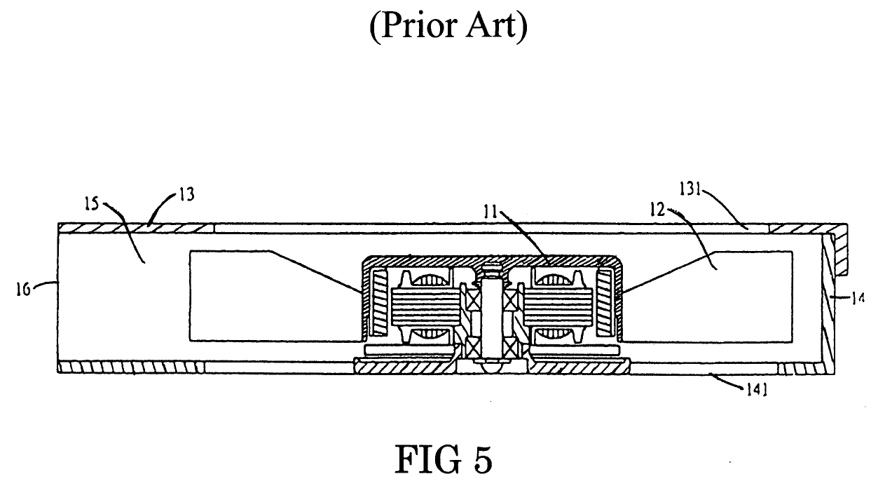

### DETAILED DESCRIPTION OF THE INVENTION

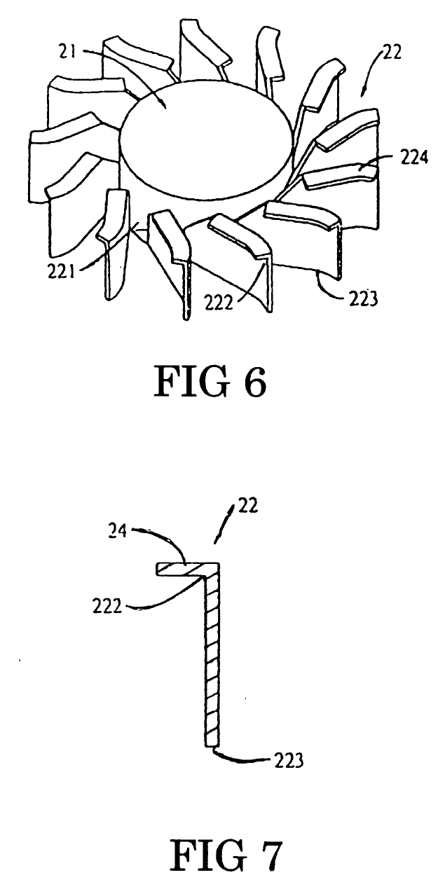

Referring to FIGS. 6 and 7, the first preferred embodiment of a fan blade unit in a centrifugal fan includes a hub 21 and a plurality of fan blades 22 surrounding the hub 21. Each of the fan blades 22 has a blade root 221 attached to the circumference of the hub 21 with two lateral sides thereof providing a first end edge 222 and a second end edge 223 opposite to first end edge 222. At least a baffle part 224 is provided at one of the end edges of each fan blade 22 and it is preferable that the baffle part 224 is disposed at the first end edge 222 and extends toward another fan blade next to it along the same direction respectively with the width of the baffle part 224 being less than the space between any two of the fan blades. Further, an angle is formed between the baffle part 224 and the fan blade 22, that is, the baffle part 224 is perpendicular to the fan blade 22 or slant to the fan blade 22.

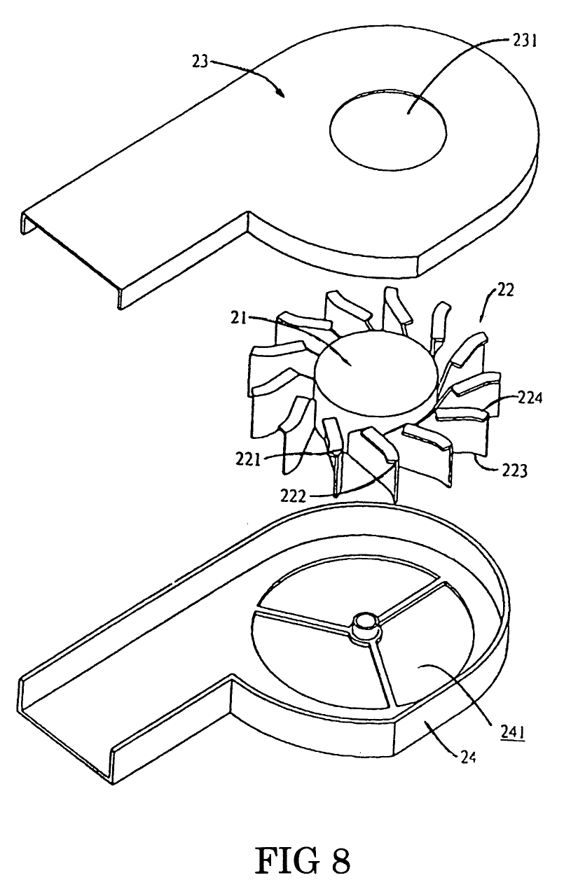

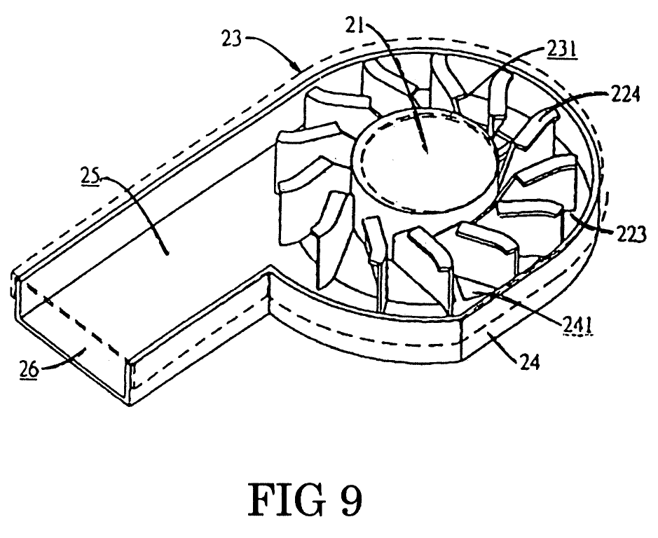

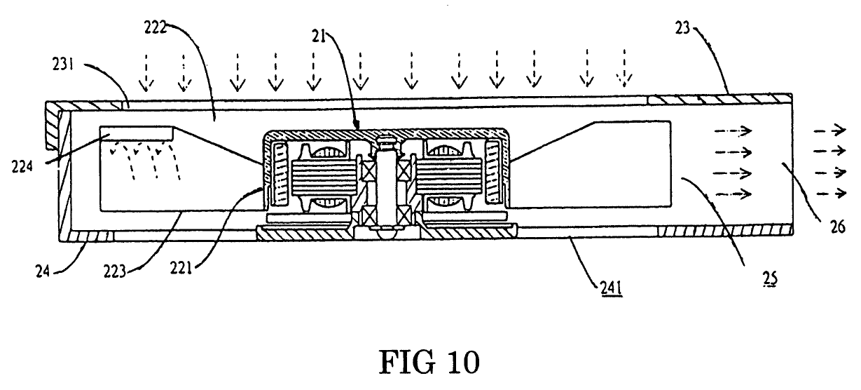

Referring to FIGS. 8, 9 and 10, the fan blade unit of the present invention is joined between an upper case member 23 and a lower case member 24. The upper case member 23 has a first hole 231 at the surface thereof and the lower case member 24 has a second hole 241 at the surface thereof. The upper case member 23 and the lower case member 24 are assembled as a single piece to define a spiral flow passage 25 to receive the hub 21 and the fan blades 22 and the upper and the lower case members 23, 24 form an outlet 26 at a lateral side thereof to communicate with the spiral flow passage 25. When the hub 21 rotates with the fan blades 22 to suck fluid, the fluid enters the case members 23, 24 via the first hole 231 and the second hole 241 and passes through passages between the fan blades 22 before the fluid is radiated outward along the fan blades by means of the dynamic force resulting from rotation. Then, the fluid is blown toward the outlet 26 along the spiral flow passage 25. When the fluid moves into passages between the fan blades 22 via the first hole 231 and the second hole 241 and resistance of the outlet 26 increases, part of the sucked fluid, which tends to flow reversely, is resisted to flow backward by the baffle part 224 and ejected outward radially along the fan blades 22. In this way, reversed flow is reduced to increase the sucked flow rate largely and noise resulting from the inflow impacting the reverse flow is diminished.

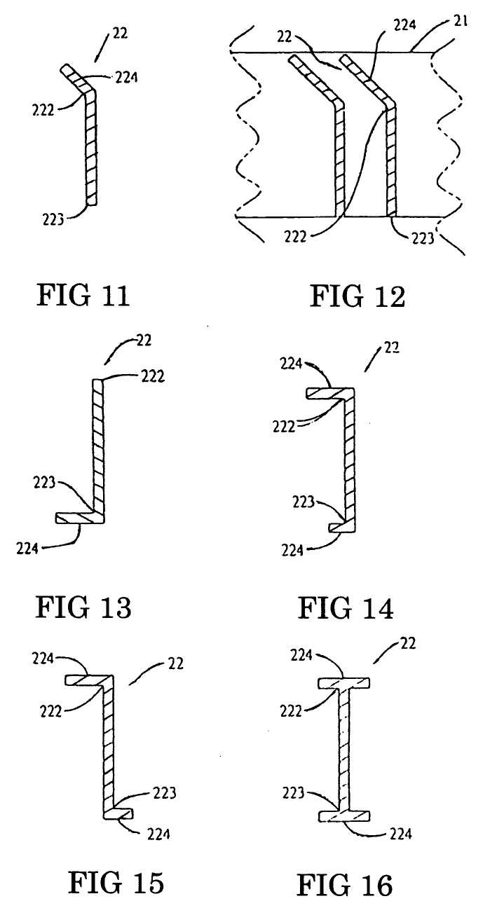

Besides, the angle between the baffle part 224 and the fan blades 22 at the first end edge 222 can be changed to an inclined angle instead of a right angle as shown in FIG. 11. The baffle part 224 can extend outward to cover another fan blade next to it or extend outward to exceed position of another fan blade next to it as shown in FIG. 12 for providing a function of shading. The baffle part 224 can be arranged at the second end edge 223 as shown in FIG. 13. The baffle part 224 can be provided at the first end edge 222 and the second end edge 224 respectively as shown in FIG. 14. The baffle part 224 at the second end edge 224 extends in a direction different from the baffle part 224 at the first end edge 222 as shown in FIG. 15. The baffle part 224 either at the first end edge 222 or at the second end edge 224 extends in two opposite directions as shown in FIG. 16. In addition, the baffle part 224 at the first end edge 222 provides either the same width as or different from the baffle part 224 at the second end edge 224.

While the invention has been described with referencing to preferred embodiments thereof, it is to be understood that modifications or variations may be easily made without departing from the spirit of this invention, which is defined by the appended claims.

What is claimed is:

1. A fan blade unit in a centrifugal fan, comprising:
a hub;
a plurality of fan blades, being connected to the periphery of the hub and each of the fan blades at least has an end edge; and
at least a baffle part, being joined to the end edge.

2. The fan blade unit in a centrifugal fan as defined in claim 1, wherein the baffle part on each of the fan blades extends another one of the fan blades adjacent to it.

3. The fan blade unit in a centrifugal fan as defined in claim 1, wherein the baffle part extends along an angle with respect the end edge.

4. The fan blade unit in a centrifugal fan as defined in claim 1, wherein the baffle part of each of the fan blades extends a width not exceeding another one of the fan blades adjacent to it.

5. The fan blade unit in a centrifugal fan as defined in claim 1, wherein the baffle part of each of the fan blades extends a width at least covering another one of the fan blades adjacent to it.

6. The fan blade unit in a centrifugal fan as defined in claim 1, wherein the baffle part of each of the fan blades extends a width at least exceeding another one of the fan blades adjacent to it.

7. The fan blade unit in a centrifugal fan as defined in claim 1, wherein the baffle part of each of the fan blades extends a unidirectional width toward another one of the fan blades adjacent to it.

8. The fan blade unit in a centrifugal fan as defined in claim 1, wherein the baffle part of each of the fan blades extends a width toward two of the fan blades adjacent to it.

9. The fan blade unit in a centrifugal fan as defined in claim 8, wherein the baffle part of each of the fan blades extends equal widths toward two of the fan blades next to it.

10. The fan blade unit in a centrifugal fan as defined in claim 8, wherein the baffle part of each of the fan blades extends unequal widths toward two of the fan blades next to it.
